(19) United States
(12) Patent Application Publication
(10) Pub. No.: US 2021/0070526 A1
(43) Pub. Date: Mar. 11, 2021

(54) MICROWAVE ACTIVE PACKAGING FOR SELECTIVE HEATING OF CONTENTS

(71) Applicant: Tillamook County Creamery Association, Tillamook, OR (US)

(72) Inventors: Fermin P. Resurreccion, JR., Tillamook, OR (US); Anna Rose Ingoglia, Tillamook, OR (US)

(73) Assignee: Tillamook County Creamery Association, Tillamook, OR (US)

(21) Appl. No.: 17/000,774

(22) Filed: Aug. 24, 2020

Related U.S. Application Data
(60) Provisional application No. 62/896,994, filed on Sep. 6, 2019.

(51) Int. Cl. B65D 81/34; B65B 5/02; B65B 25/22; A23G 9/48; A21D 13/10

(52) U.S. Cl. CPC B65D 81/3453; B65B 5/02; B65B 25/22; A23G 9/48; B65D 2581/3472; B65D 2581/3405; B65D 2581/3428; B65D 2581/344; B65D 2581/3447; A21D 13/10

(57) ABSTRACT

Frozen desserts contained in a microwave active packaging are disclosed. In some embodiments, the microwave active packaging includes a microwave active layer configured to selectively heat the contents of the microwave active packaging. The contents may include a first layer of frozen food, and one or more additional topping layers. When placed into a microwave, the microwave active layer causes the one or more additional topping layers to heat, while the first layer is maintained at or below a freezing temperature. Other embodiments may be described and/or claimed.

### CROSS-REFERENCE TO RELATED APPLICATION

This application claims the priority benefit of the earlier filing date of U.S. Provisional Application No. 62/896,994, filed Sep. 6, 2019, which is hereby incorporated herein by reference in its entirety.

### TECHNICAL FIELD

Disclosed embodiments are generally related to microwaveable packaging for food, and specifically to packaging that is microwave-active to provide selective heating of only a portion of the contents, while substantially shielding the remaining contents.

### BACKGROUND

Microwave ovens have been used for decades to prepare food, and are a ubiquitous fixture nearly everywhere food is prepared. The principle of a microwave oven is well known. Electromagnetic (EM) waves, typically in the gigahertz range, are directed into a metal-lined chamber, into which food is placed. The EM waves create a field that excites partially polar molecules in the food by causing them to align with the field. When the field drops, the molecules relax to their former non-aligned state, releasing energy in the form of heat. Thus, a microwave oven effectively causes food to heat internally and cook itself. The EM waves themselves are not thermally “hot,” unlike the resistive elements found in conventional ovens, but impart energy to the polar molecules that increases their temperature. The metallic construction of the chamber reflects the EM waves and sets up an EM field within the chamber, helping to maximize exposure of the food to the EM field, and helping to maximize the heating effect. As a result, food can be efficiently cooked in a fraction of the time it would take in a conventional oven, or even convection oven.

The background description provided herein is for the purpose of generally presenting the context of the disclosure. Unless otherwise indicated herein, the materials described in this section are not prior art to the claims in this application and are not admitted to be prior art by inclusion in this section.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 depicts an example frozen dessert contained in a microwave-active package, in complete and cross-sectional views, according to various embodiments.

FIG. 2 depicts an example microwave active layer formed into a cylindrical or frusto-conical shape that may be used to implement a microwave active layer of the example package of FIG. 1, according to various embodiments.

FIG. 3 depicts an example microwave active layer in a planar fashion that may be used to form the example microwave active layer depicted in FIG. 2, according to various embodiments.

FIG. 4 depicts the constituent layers of a microwave active layer that may be used to form the example microwave active layer depicted in FIG. 2, according to various embodiments.

FIG. 5 is a flow chart of the operations of an example method for manufacturing a frozen dessert in a microwave active package, such as the example microwave active package of FIG. 1, according to various embodiments.

### DETAILED DESCRIPTION

In the following detailed description, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Aspects of the disclosure are disclosed in the accompanying description. Alternate embodiments of the present disclosure and their equivalents may be devised without parting from the spirit or scope of the present disclosure. It should be noted that like elements disclosed below are indicated by like reference numbers in the drawings.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

Many microwave ovens found in a typical home produce EM waves at a single fixed power, with the EM field-generating magnetron either on at full power, or shut off. Changing the power level setting on such a microwave oven causes the oven to cycle the magnetron on for predetermined intervals, with the magnetron shut off between intervals to allow heat to disperse through the food. Newer microwave ovens that employ inverter power supplies are capable of modulating the power output of the magnetron (or may employ a solid-state microwave generator), allowing the microwave generator to run essentially continuously, but at a lower power level. In either case, the result is effectively the same, with the degree of food heating ultimately determined by the amount of time the food is subject to microwave exposure. Cooking food thus requires selecting an appropriate amount of time (generally, inverter microwave ovens that run continuously at all power levels require less time) and, where appropriate, a power setting, to bring the food up to a desired temperature.

Due to a variety of variables, e.g., water content, food composition, food size, uniformity of heating, magnetron power, whether the magnetron can be run at a variable power level or is periodically cycled between off and full power, to name a few, different foods will require different cook times. Where multiple foods are to be prepared, this typically necessitates either selecting foods that can be microwaved together (e.g., the foods should be heated to approximately the same temperature) and increasing the overall cook time to compensate for the increased food size. Alternatively, each food can be microwaved separately, such as where some foods are to be brought to a lower temperature than others or would heat at different rates. Manufacturers of processed foods, aware of these limitations, have developed various techniques in food preparation and arrangement to allow production of pre-packaged meals and other dishes with a variety of foods that can be heated together simultaneously.

Despite generating heat within food, food cooked with a microwave oven often does not heat evenly. Interference patterns and standing waves created by the reflections of microwaves from the interior of the microwave chamber can result in some portions of food receiving a greater amount of microwaves than other portions, thus causing those portions to heat at different rates. Other factors affecting heating can include magnetron (or microwave generator) power and frequency, where different frequencies can penetrate to different depths within the food; food geometry, where food with sharp or drastic corners potentially absorb energy from the microwave field differently than food lacking drastic corners; overall food size/mass; and the starting temperature of the food, which can affect the food's dielectric properties (e.g., frozen food may absorb less microwave radiation compared to refrigerated or room temperature food, which may result in an acceleration of heating as frozen food begins to thaw). Further, because the food composition affects how the food absorbs microwaves in generating heat (among other factors), microwaves may only penetrate the food a relatively short distance, particularly with larger food portions and/or food that is relatively high in microwave-active substances, resulting in interior portions of the food being colder than exterior portions.

Because microwave ovens cook food via internal heating from excitation of partially polar molecules instead of external convective or radiative heating used by a conventional oven, food heated to comparable temperatures may nevertheless cook differently than if cooked in a conventional oven. For example, foods that typically are browned on the outside, such as pies or rolls, are usually not browned by cooking in a microwave oven. This is because the browning is a result of both the longer cook time required in a conventional oven and the external heating that heats the surface of the food faster than the interior of the food, which induces the Maillard reaction which gives browned foods their characteristic color and flavor.

To compensate for these differences and achieve effects more comparable to a conventional oven, manufacturers of processed foods may insert metallic or metallized layer in portions of food packaging. These metallic or metallized layers can reflect microwaves, altering the pattern of the EM field within the microwave chamber, and potentially shielding selected food areas. For example, a food may be placed at least partially within a foil-lined compartment, which serves to reflect microwaves away from the food, potentially reducing exposure of the food to the EM field. In another example, the metallic or metallized layers may be configured to generate heat when bombarded by microwaves, e.g. by using discontinuous vacuum-deposited metal particles within a carrier (typically referred to as a susceptor), thus acting similar to a conventional oven and causing browning of adjacent food. In still other examples, a lossless flexible film or other plastic sheet may be placed on top of the food to retain moisture and heat.

While these techniques may be used to improve preparation of food in microwaves that are intended to be served hot, some dishes may call for a combination of foods, some of which are intended to be kept cold. For example, an ice cream sundae, in addition to having ice cream which is intended to remain below freezing, may include one or more toppings intended to be heated, e.g. caramel, hot fudge, cookie, brownie, etc. Typically, such dishes would be prepared by separately by the consumer heating the hot items in a microwave oven, and then assembling together with the ice cream. Providing a pre-assembled sundae including both ice cream and toppings would require the entire ensemble be kept below freezing. Unless the ice cream is substantially kept from exposure to the EM field in the microwave oven, subsequent heating in a microwave oven to bring the toppings up to an enjoyable temperature would also result in the ice cream melting, ruining the dessert.

Furthermore, in some cases, due to the varying composition of different food types and/or the desire that each part of the dish have a different temperature, one part of the food (such as the cookie) may preferably be heated to a first temperature, a second part of the food (such as the hot fudge or caramel topping) may preferably be heated to a second temperature, while a third part of the food (such as the ice cream) may preferably be kept in a chilled or frozen state, or heated to a third temperature. It should be understood that a given temperature may not necessarily be a specific temperature, but rather a preferred or predetermined range. To achieve such varying temperatures with existing packaging may require multiple passes within the microwave for varying times, and/or at varying power levels. In some cases, the packaging may need to be manipulated in the process, such as by removing or retracting layers, adding in food at certain times, or other multiple steps for preparation. These steps increase the time necessary to prepare a dish, and introduce the possibility of missing or mis-executing a step or steps, which can result in an improperly heated dish.

Disclosed embodiments are directed to microwave active packaging that allows contents to be heated selectively, within a single pass within a microwave. For example, in some embodiments the packaging may allow only a portion of the contents to be heated via EM waves, with the remainder of the contents being shielded from the EM waves, and so effectively not heated. In various embodiments, shielding is provided by one or more metalized layers (e.g. a microwave active layer) arranged within the packaging, to reflect the EM waves. In some embodiments, in addition to shielding layers, portions of food within the package that are intended to be heated may also be arranged to act as a shielding layer by absorbing EM waves, thereby protecting food or other contents beneath or behind the food portions from being heated. Such an arrangement of shielding layers potentially in combination with multiple layers of foods of different types can allow one or more layers of food to be maintained at or below a predetermined temperature, while other layers are heated, potentially to at or above a second predetermined temperature. By varying the arrangement of layers, as well as the dimensions and features of shielding layers, e.g. apertures, locations, sizes, etc., different layers of food can be either maintained or heated to various different predetermined temperatures or ranges of temperatures, as appropriate for a given type of food. Thus, a frozen treat, such as a sundae, could be provided in a pre-packaged form that could be heated in a microwave oven. The packaging and arrangement of food components would ensure that the toppings are heated, while the ice cream stays below the freezing point or another temperature that would result in the ice cream having an undesirable texture. Furthermore, an arrangement of food layers and/or shielding per the disclosed embodiments can allow a dish to be heated using a single pass within a microwave, potentially at a single power level, greatly simplifying preparation and helping to ensure that all portions of the food are properly heated, even to different temperatures for each layer.

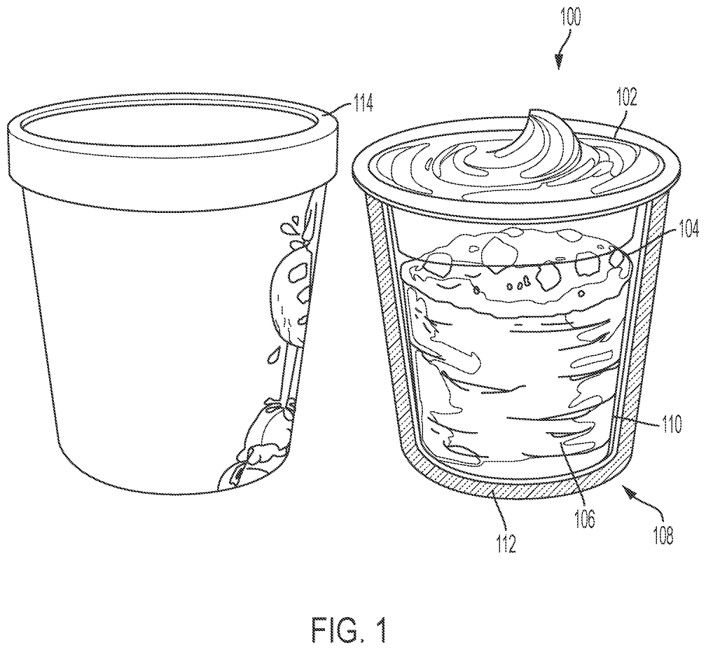

FIG. 1 illustrates an example pre-packaged frozen dessert 100 that is enclosed in a microwave active package 108, according to one possible embodiment. As may be seen, the dessert 100 includes a first layer 102, second layer 104, and a third layer 106. As depicted, dessert 100 is an ice cream sundae, where first layer 102 is a sauce such as caramel or fudge, second layer 104 is a cookie, and third layer 106 is ice cream. First layer 102 and second layer 104 are intended to be heated when the dessert 100 is placed into a microwave oven, while third layer 106, as ice cream, should remain substantially frozen. Microwave active package 108, as will be explained below, is configured to allow selective heating of only first layer 102 and second layer 104 when placed in a microwave oven, while allowing third layer 106 to remain substantially unheated. Other examples of dessert 100 may have greater or fewer than three layers.

As discussed above, the nature of a given food layer may affect how it responds to microwave radiation. Thus, the food layers 102, 104, and 106 can be arranged so that some layers act to shield at least a portion of the other layers. For example, if one layer of food is more susceptible to heating from microwave exposure, it may be placed behind other layers that absorb microwave radiation without becoming excessively hot. The other layers thus attenuate the amount of microwave radiation that reaches the more susceptible layer. In one possible configuration, a food layer that is microwave absorbing but not susceptible to rapid heating may be placed over a second food layer that is more susceptible to rapid heating. On exposure to microwave radiation, the first food layer may attenuate microwave radiation reaching the second layer sufficiently that, overall, both layers will rise to approximately the same temperature. A third layer may be placed beneath the first two layers, and be substantially shielded from any microwave heating. In this example, it is assumed that only the first (top) layer of food is exposed to incident microwave radiation, while the remaining layers are shielded such that any microwave radiation exposure must first pass through the top layer (and the second layer, in the case of the third layer). In another possible configuration, two food layers may be equally susceptible to microwave heating and be approximately equal in microwave absorption. A first layer may be placed atop the second layer, and result in the first layer heating to a higher temperature than the second layer. The layers can thus be arranged in the order of desired temperature preference. It will be understood by a person skilled in the art that the food layer order, when the food is to be exposed to microwave radiation, can be selected to achieve varying levels of heating in each layer. Other factors, such as food layer thickness/depth and ingredients may be capable of being adjusted to achieve a target temperature or range of desired temperatures.

The microwave active package 108, in the disclosed embodiment, includes an internal insulation layer 110 that is proximate to the third layer 106, and a microwave active layer 112 that is disposed upon the exterior of insulation layer 110, opposite the side of insulation layer 110 that is proximate to the third layer 106. Microwave active layer 112 will be discussed in greater detail below. In other embodiments, additional layers may be disposed upon or proximate to the exterior of the microwave active layer 112, opposite to the side disposed upon insulation layer 110, and/or upon the interior of insulation layer 110, between insulation layer 110 and third layer 106, depending upon the specifics of a given implementation. Still other embodiments may omit insulation layer 110 or replace it with one or more layers that may serve a function appropriate to a given implementation. In embodiments including multiple microwave active layers 112, one or more of the microwave active layers 112 may be of a different configuration from the other microwave active layers 112. The different configurations may be designed to achieve a desired behavior or behaviors of the microwave active package 108 when exposed to the EM field during microwave cooking, such as attenuating the EM field strength to a desired level and/or converting at least a portion of the EM field to heat (e.g. a susceptor).

Insulation layer 110, in the depicted embodiment, can protect the contents of the various layers 102, 104, and/or 106 from external heat sources, such as ambient temperatures when dessert 100 is removed from a freezer environment and/or when dessert 100 is being held. Insulation layer 110 may also protect frozen layer 106 from any heat that may be generated within microwave active layer 112 while dessert 100 is being heated in a microwave oven. Similarly, when layers 102 and/or 104, and any additional layers that may be subject to heating, are heated in a microwave, insulation layer 110 may additionally or alternatively protect a consumer from being burned by the heated layers. Insulation layer 110 may extend substantially the entire height or only a portion of microwave active package 108, as appropriate to the contents of microwave active package 108.

Insulation layer 110 may be constructed from any suitable insulating material, selected with regard to the anticipated amount of time that dessert 100 may be removed from a freezer environment. Such materials may include a plastic or polymer which may entrap air, such as polystyrene, which enhances its insulating properties, or another microwave-neutral or non-reactive material that offers a desired level of insulation, or a combination of such materials. The thickness of insulation layer 110 may be selected with regard to the expected level of heat to which insulation layer 110 may be exposed. In some embodiments, insulation layer 110 may be of a uniform thickness, while in other embodiments, insulation layer 110 may be of varying thickness, with the thickness varying depending upon the insulation requirements of various parts of dessert 100 and microwave active package 108. Where insulation layer 110 is in direct contact with one or more of the layers 102, 104, and/or 106, insulation layer 110 may be constructed from or coated with food-safe materials. Alternatively, microwave active package 108 may have a food-safe layer disposed between the interior surface of insulation layer 110 and the one or more layers 102, 104, and/or 106. Still further, insulation layer 110 may, in some embodiments, incorporate or encapsulate some or all of a microwave active layer 112.

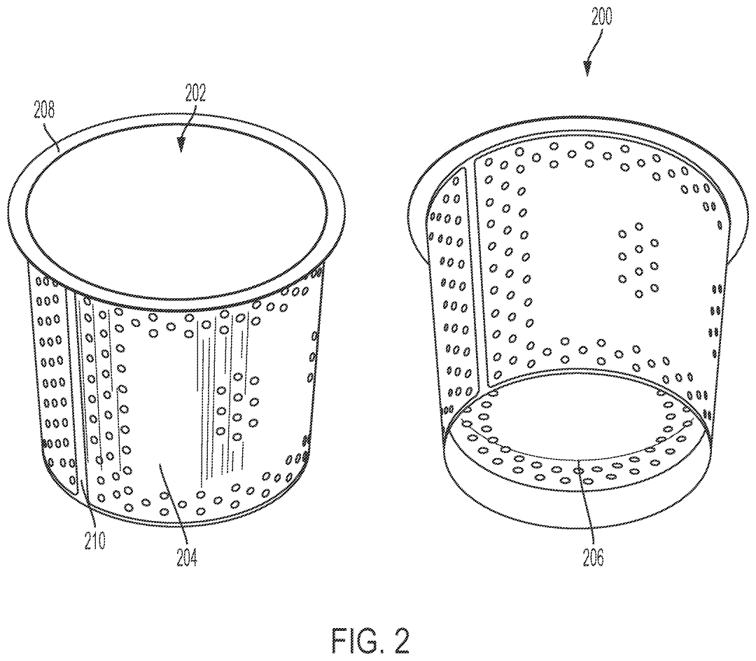

Microwave active layer 112 provides interaction between the microwave active package 108 and a microwave oven into which dessert 100 may be inserted. The specifics of microwave active layer 112 will be discussed below with respect to FIGS. 2-4.

As shown in FIG. 1, frozen dessert 100 may also include a lid 114. In some embodiments, lid 114 may be removed prior to placing frozen dessert 100 into a microwave oven. In other embodiments, lid 114 may be manufactured from a microwave-safe material that is otherwise not microwave active, and may be retained upon frozen dessert 100 in the microwave, to retain heat, moisture, and/or to prevent splatter of the contents of frozen dessert 100 into the microwave oven chamber. In some embodiments, lid 114 may include an insulation layer 110 to preserve the contents of microwave active package 108 at a relatively cold temperature until the contents are ready for preparation and consumption. In still other embodiments, lid 114 may be microwave-active or include a microwave active layer similar to microwave active layer 112, and so contribute to the cooking characteristics of the microwave active package 108, depending upon the needs of a given embodiment.

While the depicted embodiment is an ice cream sundae with toppings, it should be appreciated that the techniques and packaging arrangements disclosed herein could be modified to be applied to any food or foods that is/are suitable for microwave heating, where more than one level of heating or temperature is desired. For example, frozen dinners, that may have multiple food types, or certain types of dishes, e.g. foods with layers that normally are prepared to different temperatures, could benefit from packaging that selectively shields some foods from microwaves while allowing others to be exposed. In some further embodiments, the shielding layers and arrangement of food layers may selectively allow complete blocking of microwaves for one or more food types or layers, a degree of attenuation of microwaves for one or more other food types or layers, and/or full exposure to microwaves for one or more of yet other food types or layers. In each case, disclosed embodiments may further allow the arrangement of different food types to be heated in a single pass (viz. single time and power level) within a microwave, with the different food types each achieving a different desired (predetermined) temperature or range of temperatures, while preserving other layers within a predetermined temperature range of a starting temperature, such as a chilled temperature or frozen state.

FIG. 2 depicts an example microwave active layer 200, according to one possible embodiment of a microwave active layer 112. Microwave active layer 200 is formed into a cup shape, with an open top 202. The layer 200 includes a sidewall 204, which is formed into a cylinder with a roughly frusto-conical shape, with open top 202 defined by one end of the shape. A bottom panel or shield 206 is disposed into the other end of the shape. As seen in FIG. 2, the bottom shield 206 may be offset from the end of the cylinder to some extent, to provide space between the panel and any surface upon which the dessert 100 may be placed. A lip or flange 208 may be formed around the end of sidewall 204 that defines the open top 202.

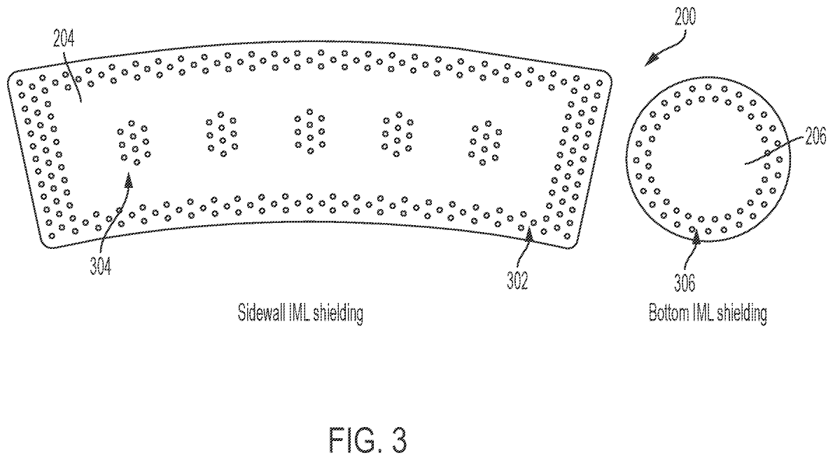

As will be discussed in greater detail below, the sidewall 204 is essentially planar in nature, and is curved around to itself to form the cylinder of microwave active layer 200 in the example depicted in FIG. 2. The ends of sidewall 204 thus meet, but do not touch, to form a gap 210. EM radiation generated by a microwave oven, as is known, can induce electric currents in metallic objects, such as a foil that may be used to form sidewall 204 and/or bottom shield 206. The inclusion of the foil or metallic layer into sidewall 204 and/or bottom shield 206 allows the layer to be microwave active. These currents, when the EM radiation is at energy levels found inside of a typical microwave oven chamber, may rise to sufficient voltage potentials to cause localized arcing, particularly where the foil presents a sharp edge or point. As arcing presents a risk of fire and/or burning of the contents of dessert 100, the ends of the foil in sidewall 204 are separated by gap 210 to prevent such arcing. This gap 210 is spaced or sized, however, to prevent substantial passage of EM radiation through the gap 210, which would otherwise compromise the shielding provided by sidewall 204. Likewise, bottom shield 206 may be attached or disposed to sidewall 204 so as to provide a gap between sidewall 204 and bottom shield 206, spaced similar to gap 210, to prevent arcing while maintaining shielding. Further, as will be noticed in FIG. 3, the corners of sidewall 204 are rounded. This rounding eliminates a possible sharp edge or point that could otherwise serve as a site for arcing or sparking.

It should be understood that the microwave active layer 200 presented in the example depicted in FIG. 2 is one layer of the several that form the microwave active package 108. As such, the gaps, such as gap 210 and the comparable gap between sidewall 204 and bottom shield 206, may be formed by virtue of how microwave active layer 200 is bonded or laminated into microwave active package 108. Furthermore, although microwave active layer 200 is described as being distinct from insulation layer 110 in the depicted embodiments, it should be understood that microwave active layer 200 may be integrated with another layer, such as insulation layer 110 or another layer that is suitably positioned to reflect or moderate microwave radiation.

Turning to FIG. 3, a possible embodiment of the microwave active layer 200 is depicted in its unfolded, planar shape. As discussed above, microwave active layer 200 includes a sidewall 204 and bottom shield 206. The surrounding edge of both sidewall 204 and bottom shield 206 contains a plurality of apertures 302 and 306, respectively. In one possible embodiment, each aperture may have a diameter of 2-3 mm, with each aperture spaced at least 3 mm from other apertures. Further, several groups of apertures 304 may be disposed along the lateral center of the sidewall 204.

As discussed above, the edges of the sidewall 204 and bottom shield 206 typically exhibit high electrical field strength during microwave heating, and are therefore prone to arcing. Further, if the lateral center in the sidewall 204 includes manufacturing imperfections such as dead folds and/or creases on the surface of the layer, these imperfections are prone to arcing. Providing the plurality of apertures 302 and 306, and groups of apertures 304, on the surface of at least the metallic portion of sidewall 204 and bottom shield 206 reduces local conductance of the metal. Areas in metal that have low conductance help deter flow of the induced current from the EM radiation field. These low conductance areas will then have a diminished chance of exceeding the breakdown voltage typically seen on the edge of the metallic foil or in surfaces with manufacturing defects that would result in localized arcing. Therefore, providing the apertures reduces arcing potential.

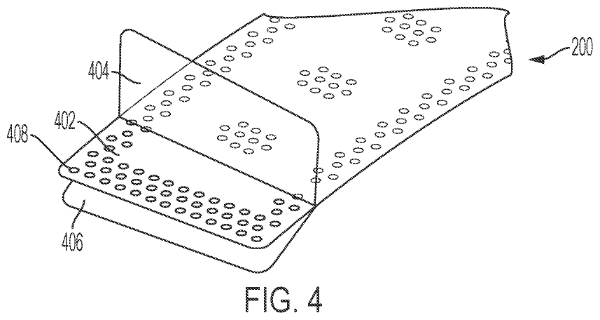

In FIG. 4, a possible construction of the microwave active layer 200, including sidewall 204 and bottom shield 206, is depicted. The microwave active layer 200 includes a metallic foil 402, which may be formed from a suitable microwave active metal, such as aluminum, and may be bonded to a carrier substrate. The metallic foil 402 in the depicted example is laminated between two flexible carrier films 404 and 406, which encase the foil and may further aid in the reduction of arc formation. The flexible carrier films 404 and 406 may, in some embodiments, extend past the edge of the metallic foil 402, to further aid in formation of the gap 210 and a gap between sidewall 204 and bottom shield 206. Flexible carrier films 404 and/or 406 may be individually formed, or may be a part of an adjacent layer to microwave active layer 200, such as an exterior label, or as part of an insulating layer, such as insulating layer 110. Metallic foil 402 includes a plurality of apertures 408, which may form a part of plurality of apertures 302 and 306, and groups of apertures 304.

The apertures 408, as discussed below, may pass through the metallic foil 402 as well as either or both flexible carrier films 404 and 406. Whether the apertures 408 pass through both flexible carrier films may depend upon how the microwave active layer 200 is adhered to other layers of the packaging. In some embodiments, such as where the microwave active layer 200 is formed as part of a package label via in-mold labeling or injection molding, the apertures 408 are only disposed through metallic foil 402, and do not otherwise extend through carrier films 404 and/or 406, or may only extend through one of the carrier films 404 or 406. In other embodiments, such as where pressure-sensitive labels are applied to the microwave active layer 200 following formation, the apertures 408 may extend through metallic foil 402, and may extend through one or both carrier films 404 and 406. The flexible carrier films 404 and 406 may be manufactured from any suitable microwave safe material, such as a plastic or paper. The material preferably both dielectric and flame resistant, so as to not catch fire in the event a spark or arc generates within metallic foil 402.

In various embodiments, each aperture 408 in the plurality of apertures 302 and 306, and the groups of apertures 304, may be formed into the metallic foil 402 by either die cutting or chemical etching process. Typically, in the die cutting process, a 7-10 μm thick metallic film (such as an aluminum foil) is laminated onto a flexible carrier film, which may be either flexible carrier film 404 or 406 or another temporary flexible carrier film, to improve web strength. In embodiments where a thicker foil may be used, the foil itself may provide sufficient web strength to pass through the rotary die cutter without the need of a carrier film. This laminate of the flexible carrier film and metallic foil 402 is then passed through a rotary die cutter, creating an impression of each aperture 408 on the surface. Where metallic foil 402 is laminated to flexible carrier film 404 or 406, the rotary die cutter may be calibrated so as to only cut through metallic foil 402, but not the flexible carrier film. Alternatively, the rotary die cutter may cut through both metallic foil 402 and the flexible carrier film, such as where the flexible carrier film is temporary, or where formation of the apertures in flexible carrier film 404 or 406 is desired. In some embodiments, metallic foil 402 may be laminated between both flexible carrier films 404 and 406, and apertures 408 will be formed through all three layers. Following the rotary die cutter, loose materials in the impressions or cuts are then removed through vacuum suction.

While the example embodiment utilizes a metallic film for metallic foil 402, other embodiments may employ a different material, such as powered metal or metal flakes that can be embedded into a carrier, such as a resin, or any other suitable material that can reflect or moderate microwave radiation.

The selection of manufacturing process and/or order of manufacturing operations for the apertures 408 may also depend upon formation of any other package structures. For example, where the microwave active layer 200 is to be integrated into a package with labeling via in-mold labeling or pressure-sensitive labeling processes, the microwave active layer 200 may need to include at least one layer that does not include any apertures 408, as such processes rely upon a vacuum for holding components in place during formation. If microwave active layer 200 includes apertures 408 through all layers, the vacuum will be unable to hold it into place during package formation.

In embodiments that employ a chemical etching process, rather than die cutting, the metallic foil 402 may be printed with a resist coat or compound in a pattern that includes the locations of each aperture 408, and then submerged into a caustic solution. Areas of metallic foil 402 that have no resist coat will readily dissolve in the solution, creating the pattern of apertures 408. In such a process, the apertures 408 will typically only form through metallic foil 402, and not the flexible carrier film.

Following formation of the apertures 408, the metallic foil 402 with the formed apertures 408, in embodiments where laminated to a temporary carrier film, may then be separated from the carrier film. The metallic foil 402 from either the die-cut or chemical etching process may be laminated between flexible carrier films 404 and 406. Where metallic foil 402 was laminated on one of flexible carrier films 404, the opposing flexible carrier film 408 may be laminated, thereby sandwiching the patterned aluminum film in between the flexible carrier film 404 and 406. This three-layer laminate structure of flexible carrier film or paper 404—patterned metallic (aluminum) film 402—flexible carrier film or paper 406 are then die-cut into shape similar to the structure illustrated in FIG. 3 (label in stack form) and can be applied to form part of microwave active package 108.

If labels will be applied to the microwave active package 108 through in-mold labeling (IML) in an injection molding, blow molding, or thermoforming process of forming a rigid container, then integration of the microwave active layer 200 into the microwave active package 108 is straight forward; the formed microwave active layer 200 may only need to be inserted into the appropriate molding or forming apparatus. However, if labels will be applied through pressure sensitive labelling (PSL) on a preformed container, then such labels may need to be laminated in another layer of sacrificial web with release coat and pressure sensitive adhesive in between. Such labels may be affixed to an exterior of microwave active layer 200. In other embodiments, the label may be formed as part of one of the flexible carrier films 404 or 406.

The shape of each aperture 408 is not limited to the circular configuration shown in the depicted embodiments. A different shape can be selected, such as triangular, honeycomb, hexagonal, wire mesh rectangular shape, etc. Selection of proper aperture shape depends on the type of manufacturing process and the complexity of the geometry of packaging container to which the label will be applied. Calculation of the diameter of the opening for a circular aperture (and the equivalent diameter for other shapes of aperture), in some embodiments, is based on the cutoff frequencies of the EM radiation generated by a typical microwave oven, at 2450 MHz (2.45 GHz).

To demonstrate how microwave active layer 200 can provide shielding with the inclusion of apertures 408, in some embodiments, each aperture 408 can be considered as a cylindrical waveguide system (i.e., cross sectional area of the cylinder will be the circular aperture), where the cutoff frequency is given by the following equations:

For transverse electric mode (TEₘₙ^{z}):

$${( {f}_{c} )}_{mn} = \frac{{χ}_{mn}^{′}}{2 π a \sqrt{μɛ}}$$

For transverse magnetic mode (TMₘₙ^{z}):

$${( {f}_{c} )}_{mn} = \frac{{χ}_{mn}}{2 π a \sqrt{μɛ}}$$

Where: χ′ₘₙ and χₘₙ represents the nth zero (n=1, 2, 3, . . . ) of the derivative of the Bessel function Jm of the first kind of order m (m=0,1, 2, 3, . . . ), a is the radius of the circular opening, and μ and ε are the permeability and permittivity of the wave, respectively.

Assuming that the cutoff frequency is equal to the frequency of the domestic microwave oven (i.e. 2.45 GHz) in free space, the 1/√με is equal to the speed of light, which is 2.9979×108 m/s. For TE₀₁^{z and TM}₁₁^{z} modes, the values of the Bessel function for χ′ₘₙ and χₘₙ are both equal to 3.8318. Plugging these values into the above equations would give the radius of the circular aperture equal to 7.5 mm or 15 mm diameter. This means that a 100% propagation of microwave at 2.45 GHz is expected for apertures equal to or greater than 15 mm. Any aperture less than 15 mm would result in reduction in microwave transmission. For an aperture filled with or in-contact to a dielectric material (food), such as aperture 408, the value of 1/√με would result in a much smaller diameter of aperture. For food applications, an aperture diameter of 2-3 mm is sufficient to prevent transmission of incident microwave field (i.e., 100% reflection). Thus, the metallic film 402 with each aperture 408 sized at 2 mm behaves as a continuous material from a transmission-reflection point of view, but would have reduced conductance local to each aperture 408, effectively reducing arc potential. It should be understood that other ways and/or considerations for selecting the size of an aperture 408 may be employed, so long as the selected aperture 408 allows microwave active layer 200 to achieve its intended shielding effect.

As discussed above, apertures less than 15 mm in diameter will result in an attenuation of microwave transmission, with the degree of attenuation increasing in inverse proportion to aperture size. In some embodiments the apertures 408 may be varied in size and location to provide varying amounts of microwave exposure/heating to desired locations of food, while maintaining shielding to other portions of the food.

Referring back to FIG. 1, the example microwave active layer 200 depicted in FIG. 2, and its constituent sidewall 204 and bottom shield 206 depicted in FIG. 3, has a height of 50-100 mm, which may vary or otherwise depend on the dielectric property of the toppings that provides partial shielding to the ice-cream. This layer may be implemented as microwave active layer 112 of microwave active package 108, depicted in FIG. 1. For example, where the microwave active layer 200 has a height of 100 mm, the 75 mm from the bottom of the microwave active package 108 will be filled with ice-cream, forming third layer 106. A ˜10 mm thick cookie, comprising second layer 104, will be placed on top of the third layer 106 of ice-cream. First layer 102, a syrup approximately 5 mm in thickness, is then disposed on top of or above the cookie of second layer 104. The remaining 10 mm will be a headspace, to accommodate thermal expansions and/or variances in production.

In the depicted embodiment, the microwave active shielding design provided by microwave active layer 112 and the assembly of the ice-cream components will allow heating of the cookie and syrup from −10° C. to a temperature greater than 50° C. for 30-45 s in a domestic microwave oven that has a power level of 1000-1200 watts. The positioning of the syrup and cookie of the first and second layers 102, 104, respectively, act to absorb the majority of EM radiation that passes through open top 202 of the microwave active layer and prevent it from reaching the third layer 106 of ice cream, with the microwave active layer 112 shielding the sides and bottom of the ice cream. The amount of EM radiation absorbed by the first and second layers 102, 104, may depend upon the composition of each layer, with food selected for each layer that has a greater loss factor than the ice cream of third layer 106. Thus, a minimal increase in the ice-cream temperature from −10° C. to about −5° C. is expected.

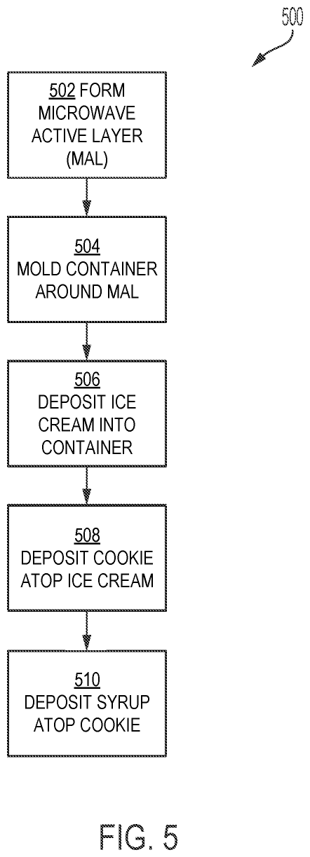

Referring to FIG. 5, the operations of an example method 500 for forming a dessert, such as a dessert 100, into a microwave active package, such as microwave active package 108, are depicted. The operations of method 500 may be performed in whole or in part, all or some of the operations may be performed, and the operations may be performed concurrently or in an order different that depicted.

Starting in operation 502, a microwave active layer (MAL) may be formed. The microwave active layer may be formed into a cylindrical frusto-conical shape with a top opening and hollow interior, as described above, with respect to microwave active layer 200 and FIGS. 2-4.

In operation 504, a container may be molded or otherwise formed around the MAL from operation 502. The container may be formed by depositing or adhering one or more layers, such as an insulation layer like insulation layer 110, about the interior of the microwave active layer. In some embodiments, a structural layer may be molded to the exterior or interior of the microwave active layer to provide the container with additional rigidity. A label may be molded or affixed to the exterior of the microwave active layer and/or the structural layer so as to be visible to a consumer of the dessert. Depending upon how label packaging is to be applied and how the container is to be formed, operations 502 and 504 may be performed concurrently or in a reverse order, depending upon the specifics of a given embodiment.

In operation 506, following formation of the container, a layer of ice cream or other frozen food may be deposited into the container. Following deposition of the ice cream, a cookie or other first topping may be disposed atop or above the frozen food, in operation 508. Finally, in operation 510 a syrup or other second topping may be disposed atop or above the cookie or other first topping.

Further additional operations may be performed where more than two topping are to be supplied; alternatively, either operation 508 or 510 may be omitted if only one topping is to be provided, e.g. if there is only a cookie or syrup.

It will be apparent to those skilled in the art that various modifications and variations can be made in the disclosed embodiments of the disclosed device and associated methods without departing from the spirit or scope of the disclosure. Thus, it is intended that the present disclosure covers the modifications and variations of the embodiments disclosed above provided that the modifications and variations come within the scope of any claims and their equivalents.

What is claimed is:

1. A microwavable food, comprising:
a first food layer comprising a food to be maintained within a first predetermined temperature range;
a second food layer comprising a second food to be maintained within a second predetermined temperature range higher than the first predetermined temperature range; and
a microwave active container at least partially enclosing the first and second food layers,
wherein the microwave active container is configured to selectively heat, when the food is placed into a microwave oven, the first layer to a temperature within the first predetermined temperature range and the second food layer to a temperature within the second predetermined temperature range.

2. The microwaveable food of claim 1, wherein the microwave active container comprises a microwave shield layer arranged to attenuate an amount of microwave radiation that reaches the first food layer.

3. The microwaveable food of claim 2, wherein the microwave shield layer comprises a metallic foil, the metallic foil further comprising a plurality of apertures sized to maintain microwave reflectance while reducing local conductivity.

4. The microwaveable food of claim 3, wherein the microwave shield layer further comprises a first polymer sheet that is disposed on a first side of the metallic foil, and a second polymer sheet that is disposed on a second side of the metallic foil.

5. The microwaveable food of claim 3, wherein each of the plurality of apertures is between 2-3 mm in diameter.

6. The microwaveable food of claim 1, wherein the first food layer and second food layer are arranged so that the second food layer attenuates an amount of microwave radiation that reaches the first food layer.

7. The microwaveable food of claim 6, wherein the microwave active container comprises a microwave shield layer arranged to prevent microwave radiation from reaching the first food layer except through the second food layer.

8. The microwaveable food of claim 1, further comprising a third food layer, the third food layer comprising a food to be maintained within a third predetermined temperature range.

9. The microwaveable food of claim 8, wherein:
the microwave active container comprises an insulation layer and a microwave shield layer;
the insulation layer and microwave shield layer partially enclose the first, second, and third food layers; and
the microwave shield layer is configured to prevent microwave radiation from reaching the first and second food layers except through the third food layer.

10. The microwaveable food of claim 8, wherein the first food layer comprises ice cream, the second food layer comprises a baked good, and the third food layer comprises a syrup.

11. A method of preparing a microwaveable food, comprising:
forming a microwave active layer;
molding a container around the microwave active layer;
depositing as first food layer into the container;
disposing a second food layer on top of the first food layer; and
disposing a third food layer on top of the second food layer,
wherein the microwave active layer is configured to cause, when the food is exposed to microwave radiation within a microwave oven, the second and third food layers at or above a first predetermined temperature, while maintaining the first food layer at or below a second predetermined temperature.

12. The method of claim 11, wherein molding a container further comprises:
molding an insulation layer around the microwave active layer;
adhering a label to an exterior surface of the insulation layer.

13. The method of claim 11, wherein forming the microwave active layer further comprises:
providing a first polymer layer;
disposing a metallized layer upon the first polymer layer; and
disposing a second polymer layer upon the metallized layer.

14. The method of claim 13, wherein forming the microwave active layer further comprises creating a plurality of apertures through the metallized layer.

15. The method of claim 14, wherein creating the plurality of apertures further comprises cutting the apertures from the metallized layer with a die cutter.

16. The method of claim 15, wherein cutting the apertures from the metallized layer further comprises cutting the apertures through the first and second polymer layers.

17. The method of claim 14, wherein creating the plurality of apertures further comprises etching the apertures into the metallized layer.
